(19) United States
(12) Patent Application Publication
(10) Pub. No.: US 2010/0323618 A1
(43) Pub. Date: Dec. 23, 2010

(54) MOBILE COMMUNICATION DEVICE

(75) Inventor: Rajiv Singh Cullen Pal, Denver, CO (US)

Correspondence Address: EchoStar Technologies, L.L.C.;Legal Department, 9601 SOUTH MERIDIAN BOULEVARD, ENGLEWOOD, CO, 80112, US

(73) Assignee: EchoStar Technologies, L.L.C, Englewood, CO (US)

(21) Appl. No.: 12/489,607

(22) Filed: Jun. 23, 2009

(51) Int. Cl. H04B 7/00; H04M 1/00; H04B 1/38

(52) U.S. Cl. 455/41.2; 455/575.1; 455/557

(57) ABSTRACT

Described herein are mobile communication devices that are insertable within a slot of a host system. The mobile communication device is sized to fit within the host system. When inserted within the slot of the host system, the mobile communication device may interface with the host system to exchange data.

### BRIEF DESCRIPTION OF THE DRAWINGS

The same number represents the same element or same type of element in all drawings.

FIG. 1 illustrates an embodiment of a communication system.

FIG. 2 illustrates an embodiment of a mobile communication device of FIG. 1.

FIG. 3 illustrates another embodiment of a mobile communication device of FIG. 1.

FIG. 4 illustrates an embodiment of a host system of FIG. 1.

### DETAILED DESCRIPTION OF THE DRAWINGS

Described herein are mobile communication devices that are insertable within a slot of a host system. As used herein, a mobile communication device may refer to a mobile telephone that provides voice communication services to a user as well as other devices that provide various types of communication services to a user, such as email, internet browsing and the like. When inserted within the slot of the host system, the mobile communication device may interface with the host system to perform various functions. For example, the mobile communication device may exchange data with the host system. The mobile communication device may also charge its battery using current supplied by the host system. In at least one embodiment, the mobile communication device may communicatively couple the host system to a wireless network, allowing the host system to communicate with remote devices through the wireless network. Further, the mobile communication device may be inserted into the host system for storage. For example, the mobile communication device may be stored within a laptop during travel by a user.

In at least one embodiment, a mobile telephone includes a housing that is insertable into a slot of a host system. For example, the housing may be adapted for insertion into a PCMCIA or PC card slot of a host system. The mobile telephone further includes a communication interface disposed on the housing that is configured to electrically interface with the host system and a network interface configured to communicate with a remote device through a wireless network. The mobile telephone includes an input interface (e.g., buttons, touch pad or the like) disposed along a surface of the housing configured to receive user input, a microphone configured to receive input audio data and a speaker configured to output audio data. Control logic of the mobile telephone is configured to process incoming and outgoing communications through the network interface (e.g., a telephone call or other type of communication, such as emails, short message service (SMS) messages, data transmissions and the like). In at least one embodiment, the control logic is operable to control the exchange of data with the host system through the communication interface. For example, the control logic may synchronize calendar data, address book data or the like with the host system.

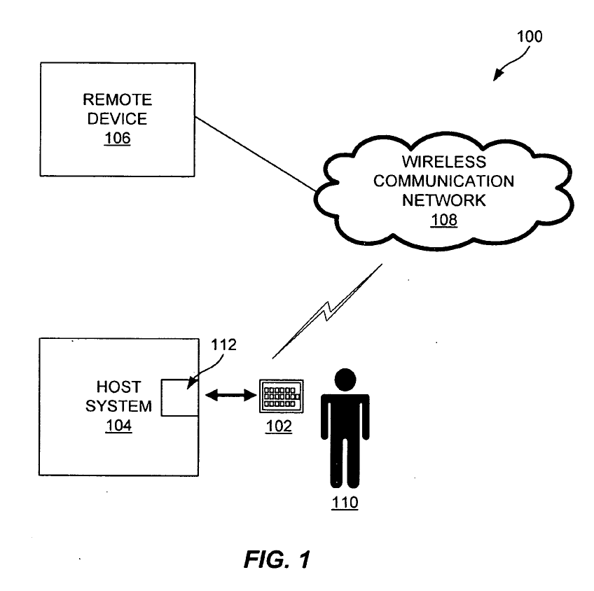

FIG. 1 illustrates an embodiment of a communication network 100. The communication network 100 includes a mobile communication device 102, a host system 104, a remote device 106 and a wireless network 108. Each of these components is discussed in greater detail below. The communication network 100 may include other elements, components or devices not illustrated for the sake of brevity.

The mobile communication device 102 is configured to communicate with the remote device 106 through the wireless network 108. The mobile communication device 102 may comprise any type of device that provides communication services to the user 110. For example, the mobile communication device 102 may be a mobile telephone that provides voice communication services to the user 110. In other embodiments, the mobile communication device 102 may comprise a mobile device with a display screen that provides data communication services to the user 110, such as email, video, internet browsing and the like. In at least one embodiment, the mobile communication device 102 is an audio playback device configured to download audio data via the wireless network 108 and output the audio data for presentation to the user 110.

The wireless network 108 may include any type of communication network that provides any type of wireless connectivity between the mobile communication device 102 and the remote device 106. Exemplary wireless networks 108 include wireless telephone networks (e.g., cellular) and wireless internet and data networks (e.g., WiFi, WiMax, ultra wide band (UWB) and the like). The mobile communication device 102 and the remote device 106 may communicate using any type of wireless protocol, including Code Division Multiple Access (CDMA), Time Division Multiple Access (TDMA), Global System for Mobile Communications (GSM) and the like.

The wireless network 108 may include a variety of components not illustrated in FIG. 1 for the sake of brevity. Such components include a plurality of base stations, a mobile switching center (MSC), a home location register (HLR) and the like. In at least one embodiment, wireless network 108 is communicatively coupled to a public switched telephone network (PSTN).

The remove device 106 may be any type of device configured to communicate with the mobile communication device 102 through the wireless network 108. In at least one embodiment, the remote device 106 may be a mobile telephone or other device that is similar to the mobile communication device 102. The remote device 106 may communicate with the mobile communication device 102 via voice communications, SMS messages, email, instant messaging and the like. In at least one embodiment, the remote device 106 comprises a server configured to provide data to the mobile communication device 102. For example, the remote device 106 may provide web pages, sports scores, news updates, audio content, video content and the like to the mobile communication device 102.

The host system 104 may comprise any type of device that includes a slot 112 for receiving the mobile communication device 102. In at least one embodiment, the host system 104 may be a desktop or laptop computer including a PC card slot capable of receiving the mobile communication device 102. The host system 104 may also comprise other types of electronic devices having a slot for receiving the mobile communication device 102, including video game systems, cameras and the like.

The mobile communication device 102 is inserted into the slot 112. In at least one embodiment, the mobile communication device 102 is configured to insert fully into the slot 112. For example, the mobile communication device 102 may be the same size as a standard PCMCIA or PC card. In some embodiments, the mobile communication device 102 may be larger than a PCMCIA or PC card. For example, the mobile communication device 102 may be sized to fit the PC card slot and may further extrude beyond the opening of the PC card slot. While the embodiments illustrated herein are described in the context of PC card slot, it is to be appreciated that the mobile communication device 102 may be sized to fit within any size slot of a host system 104.

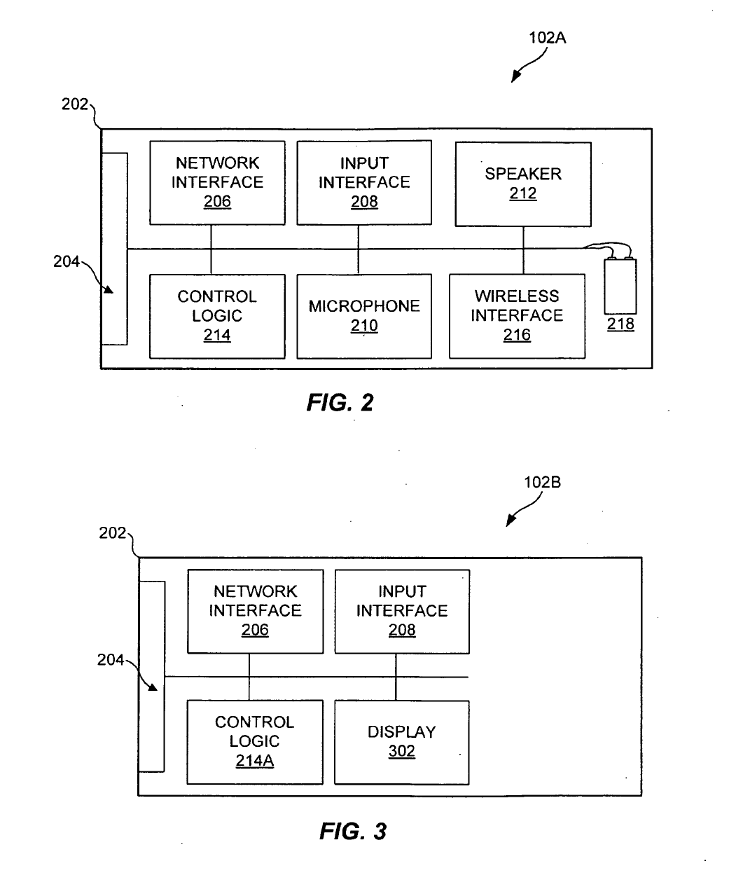

FIG. 2 illustrates an embodiment of a mobile communication device of FIG. 1. The mobile communication device 102A will be described in reference to the communication network 100 of FIG. 1. The mobile communication device 102A includes a housing 202, a communication interface 204, a network interface 206, an input interface 208, a microphone 210, a speaker 212, control logic 214 and a battery 218. In at least one embodiment, the mobile communication device 102A includes an optional wireless interface 216. Each of these components is discussed in greater detail below. The mobile communication device 102A may include other elements, components or devices not illustrated for the sake of brevity.

The housing 202 is configured for insertion into the slot 112 (see FIG. 1) of the host system 104. In at least one embodiment, the housing 202 is configured for insertion into a PC card slot. For example, the housing 202 may be 85.6 mm long and 54.00 mm wide. Exemplary thicknesses of PC cards that fit within PC card slots include 3.3 mm, 5.0 mm, 5.5 mm, 10.5 mm and 16 mm. It will be appreciated that the dimensions of the housing 202 may vary depending on desired design criteria and may be sized appropriately to fit within the slot 112.

The communication interface 204 is disposed along an edge of the housing 202. The communication interface 204 is configured to electrically interface with the host system 104. In at least one embodiment, the communication interface 204 includes a 68 pin dual row connecting interface that couples to a similar interface within the slot 112.

The network interface 206 is configured to communicate with the wireless network 108. More particularly, the network interface 206 is configured to communicate with the remote device 106 through the wireless network 108. The network interface 206 may comprise any type of wireless transceiver configured to communicate with the wireless network 108. The network interface 206 may utilize any type of wireless communication protocol depending on desired design criteria.

The input interface 208 is disposed along a surface of the housing 202. The input interface 208 is configured to receive input from the user 110 (see FIG. 1). In at least one embodiment, the input interface 208 includes one or more buttons or keys configured to receive the user input. The input interface 208 may include other types of man-machine interfaces, including trackballs, rocker switches, touch pads, touch screens and the like. In at least one embodiment, the input interface 208 is configured to receive voice input from the user 110.

The microphone 210 is configured to receive voice data from the user 110. The speaker 212 is configured to output audio data to the user 110. The microphone 210 and the speaker 212 may be positioned at appropriate locations within or on the surface of the housing 202.

The control logic 214 is operable to control the operation of the mobile communication device 102A. The control logic 214 may be a single processing device or a plurality of processing devices that cooperatively operate to control the operation of the mobile communication device 102A. In at least one embodiment, the control logic 214 is operable to control telephone communications between the mobile communication device 102A and the remote device 106 (see FIG. 1).

For example, the user 110 may provide input to the input interface 208 requesting to place a phone call to a desired phone number. The control logic 214 initiates a phone call to the remote device 106 through the network interface 206. As the user 110 speaks into the microphone 210, the control logic controls the processing of the audio data received by the microphone 210 and initiates transmission of the audio data to the remote device 106 through the network interface 206. Similarly, the network interface 206 receives data from the remote device 106 and the control logic 214 controls the output of the audio data by the speaker 212.

When the housing 202 is inserted into the slot 112 (see FIG. 1) of the host system 104, the control logic 214 is additionally configured to control the interfacing between the host system 104 and the mobile communication device 102A. For example, the host system 104 may exchange data with the mobile communication device 102A through the communication interface 204. In at least one embodiment, the host system 104 may exchange calendar data, address book data, photos, music, videos and other types of data with the mobile communication device 102A.

In at least one embodiment, the host system 104 provides current to the mobile communication device 102A through the communication interface 204. The mobile communication device 102 utilizes the current received through the communication interface 204 to charge its battery 218. In at least one embodiment, the control logic 214 is operable to control the charging of the battery 218 using the current supplied from the host system 104 through the communication interface 204.

In at least one embodiment, the mobile communication device 102 communicatively couples the host system 104 to the wireless network 108. For example, the network interface 206 may receive data from the wireless network 108 destined for the host system 104. The control logic 214 processes the received data and initiates transmission of the data to the host system 104 through the communication interface 204. Similarly, the host system 104 may transmit data to the mobile communication device 102A through the communication interface 204. The control logic 214 processes the data and initiates transmission of the data to the wireless network 108 through the network interface 206.

In some embodiments, the mobile communication device 102A may include a wireless interface 216 configured to communicatively couple the mobile communication device 102A and the host system 104 when the mobile communication device 102A is removed from the slot 112. For example, the wireless interface 216 may communicate with the host system 104 through an infrared (IR) communication link, Bluetooth, WiFi or other type of RF communication link. The mobile communication device 102A and the host system 104 may exchange any type of data over the wireless communication link through the wireless interface 216. For example, the mobile communication device 102A may receive an SMS message from the wireless network 108 and the wireless interface 216 may transmit the SMS message to the host system 104 for display to the user 110 while the user is engaged in a telephone conversation.

In at least one embodiment, the host system 104 may be configured to record a voice conversation on the mobile communication device 102A. As the user 110 engages in the voice conversation on the mobile communication device 102A, the control logic 214 directs the transmission of data associated with the voice conversation to the host system 104 through the wireless interface 216. In at least one embodiment, the wireless communication link between the host system 104 and the wireless interface 216 is encrypted or otherwise secured from interception by third parties. The host device 104 receives the data from the wireless interface 216 and stores the data in memory for subsequent retrieval by the user 110.

In some embodiments, the host device 104 may be utilized to provide speakerphone services for the mobile communication device 102A. As the network interface 206 receives voice communications from the wireless communication network 108 (see FIG. 1), the control logic 214 controls the transmission of the communications to the host device 104 through the wireless interface 216. The host device 104 receives the communications from the wireless interface 216 and outputs audio data to the user 110 via a speaker associated with the host device 110.

FIG. 3 illustrates another embodiment of a mobile communication device of FIG. 1. The mobile communication device 102B will be described in reference to the communication network 100 of FIG. 1. The mobile communication device 102B includes a housing 202, a communication interface 204, a network interface 206, a display 302 and control logic 214A. Each of these components is discussed in greater detail below. The mobile communication device 102A may include other elements, components or devices not illustrated for the sake of brevity and the discussion of components common to FIG. 2 is omitted herein.

The display 302 is disposed along a surface of the housing. The display 302 is configured to present information to the user 110. In at least one embodiment, the communication interface 204 is configured to receive data from the wireless network 108, such as email messages. The control logic 214A is operable to receive the incoming email messages from a remote device 106 via the network interface 206 and initiate output of corresponding data on the display 302. In at least one embodiment, the display 302 is a touch screen that the user 110 may utilize to input data into the mobile communication device 102B. It is to be appreciated that the mobile communication device 102B may be configured to provide for the reception and output of any type of data from the wireless network 108, depending on desired design criteria.

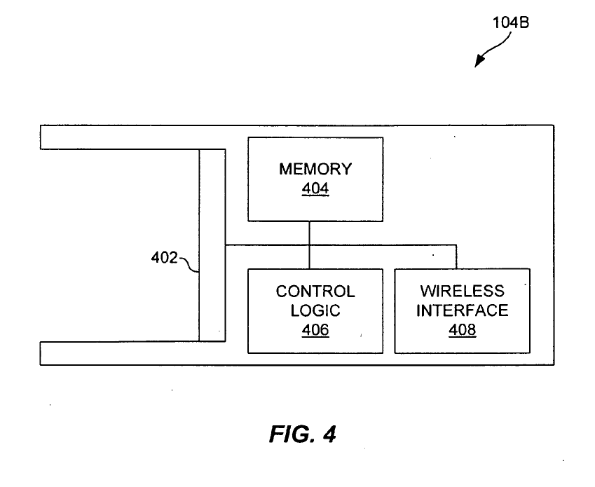

FIG. 4 illustrates an embodiment of a host system of FIG. 1. The host system 104A will be described in reference to the communication network 100 of FIG. 1. The host system 104A includes a slot 112, a communication interface 402, a memory 404, control logic 406 and a wireless interface 408. Each of these components is discussed in greater detail below.

As described above, the slot 112 is configured to receive a mobile communication device 102. The slot 112 includes a communication interface 402 disposed therein that electrically interfaces with the mobile communication device 102. The communication interface 402 may be similar to the communication interface 204 (see FIG. 2). More particularly, the communication interface 402 is configured to mate with the communication interface 204, electrically coupling the host system 104A to the mobile communication device 102.

The memory 404 is operable to store data of the host system 104A. The memory 404 may comprise any type of volatile or non-volatile memory. Exemplary memory 404 includes semiconductor random access memory (RAM), flash memory, magnetic memory and the like. Data stored in memory 404 may include address book data, calendar data, files, pictures, music, videos, emails and the like.

The control logic 406 is operable to control the operation of the host system 104A. The control logic 406 may be a single processing device or a plurality of processing devices that cooperatively operate to control the operation of the host system 104A. In at least one embodiment, the control logic 406 is operable to control the exchange of data with the mobile communication device 102 through the communication interface 402. For example, the control logic 406 may control the synchronization of the data stored in the memory 404 with information stored in the mobile communication device 102. In some embodiments, the control logic 406 may also upload or download data from the mobile communication device 102.

In some embodiments, the host device 1048 may include a wireless interface 408 to communicate with the mobile communication device 102 when the mobile communication device 102 is removed from the slot 112. The wireless interface 408 is configured to exchange messages with the mobile communication device 102 through the wireless interface 408. For example, the mobile communication device 102 may transmit data to the host system 104A through the wireless interface 408. The control logic 406 may process the received data and output the data for presentation by an associated presentation device (e.g., a monitor). Thus, the user 110 (see FIG. 1) may view data on the host system 104A while engaged in a telephone conversation using the mobile communication device 102.

Although specific embodiments were described herein, the scope of the invention is not limited to those specific embodiments. The scope of the invention is defined by the following claims and any equivalents therein.

I claim:

1. A mobile telephone comprising:
a housing that is insertable into a slot of a host system;
a communication interface disposed on the housing configured to electrically interface with the host system;
a network interface configured to communicate with a remote device through a wireless network;
an input interface disposed along a surface of the housing configured to receive user input;
a microphone configured to receive input audio data;
a speaker; and
control logic configured to:
receive incoming communications from the remote device through the network interface and initiate output of corresponding output audio data through the speaker;
transmit outgoing communications to the remote device based on the input audio data and the user input; and
control the exchange of data with the host system through the communication interface.

2. The mobile telephone of claim 1, wherein the communication interface is disposed along an edge of the housing.

3. The mobile telephone of claim 1, wherein the housing is configured for insertion into a PC card slot of the host system.

4. The mobile telephone of claim 1, wherein the communication interface is configured to receive electrical current from the host system, the electrical current utilized to charge a battery of the mobile telephone.

5. The mobile telephone of claim 1, wherein the communication interface is configured to synchronize data stored in a memory of the mobile telephone with information stored in the host system.

6. The mobile telephone of claim 1, wherein the input interface comprises a touch pad.

7. The mobile telephone of claim 6, wherein the input interface comprises a touch screen.

8. The mobile telephone of claim 1, wherein the input interface comprises a plurality of keys.

9. The mobile telephone of claim 1, further comprising a wireless interface, the wireless interface configured to communicatively couple the mobile telephone to the host system when the mobile telephone is removed from the slot, the control logic configured to initiate the exchange of messages with the host system through the wireless interface.

10. The mobile telephone of claim 9, wherein the wireless interface comprises an IR transceiver.

11. The mobile telephone of claim 9, wherein the wireless interface comprises a Bluetooth transceiver.

12. A mobile communication device comprising:
a housing that is insertable into a slot of a host system;
a communication interface disposed along an edge of the housing configured to electrically interface with the host system;
a network interface configured to communicate with a remote device through a wireless network;
a display; and
control logic configured to:
receive incoming communications from the remote device through the network interface and responsively initiate output of data on the display based on the incoming communications; and
control the exchange of data with the host system through the communication interface.

13. The mobile communication device of claim 12, wherein the housing is configured for insertion into a PC card slot of the host system.

14. The mobile communication device of claim 12, wherein the interface is configured to receive electrical current from the host system, the electrical current utilized to charge a battery of the mobile telephone.

15. The mobile communication device of claim 12, wherein the communication interface is configured to synchronize data stored in a memory of the mobile telephone with information stored in the host system.

16. The mobile communication device of claim 12, wherein the display comprises a touch screen.

17. The mobile communication device of claim 12, further comprising:
a microphone configured to receive input audio data;
a speaker; and
control logic configured to:
receive incoming communications from the remote device through the network interface and initiate output of corresponding output audio data through the speaker; and
transmit outgoing communications to the remote device based on the input audio data and the user input.

18. A host system comprising:
a slot that receives a mobile communication device, the mobile communication device including a housing configured for insertion into the slot;
a communication interface disposed within the slot that electrically interfaces with the mobile communication device;
a memory storing data; and
control logic configured to synchronize the data stored in the memory with information stored in the mobile communication device.

19. The host system of claim 18, wherein the communication interface is configured to provide electrical current to the mobile communication device, the electrical current utilized to charge a battery of the mobile communication device.

20. The host system of claim 18, further comprising a wireless interface, the wireless interface configured to communicatively couple the mobile communication device to the control logic when the mobile communication device is removed from the slot, the wireless interface configured to exchange messages with the mobile telephone through the wireless interface.
